(19) United States
(12) Patent Application Publication
(10) Pub. No.: US 2010/0178449 A1
(43) Pub. Date: Jul. 15, 2010

(54) Hanging type energy saving window film

(75) Inventors: Yi Hu, Shanghai (CN); Han Hu, Shanghai (CN)

Correspondence Address: Ming Hu;c/o Yi Hu, 10 Emmet Ct., Piscataway, NJ, 08854, US

(73) Assignee: Yi Hu, Shanghai (CN)

(21) Appl. No.: 12/319,827

(22) Filed: Jan. 14, 2009

(51) Int. Cl. B32B 3/06

(52) U.S. Cl. 428/100

(57) ABSTRACT

Hanging type energy saving window film consists of a clear or tinted plastic film that hangs down from the wall to cover the window and serves to control the transfer of heat and light for energy saving purposes. Hanging type energy saving window film includes a film, a hanging system, a weight, and a sealing system. The hanging type energy saving window film covers the entire window on the inside of a room to insulate and control light and heat transfer. A clear window film allows light to enter the room and also reduces the amount of heat that escapes through the window pane during winter. A colored window film blocks sunlight and insulates the window to save energy. Hanging type energy saving window film may comprise a hook system, a roller curtain system, or a motorized roller curtain system.

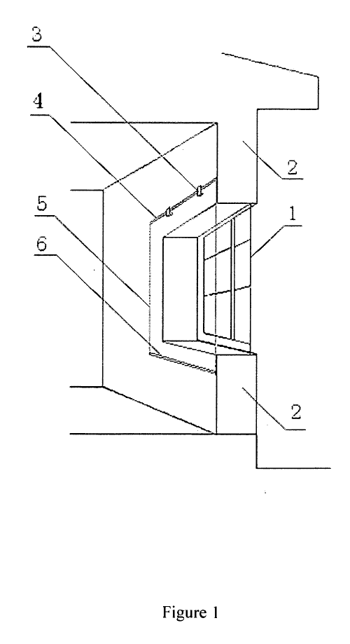

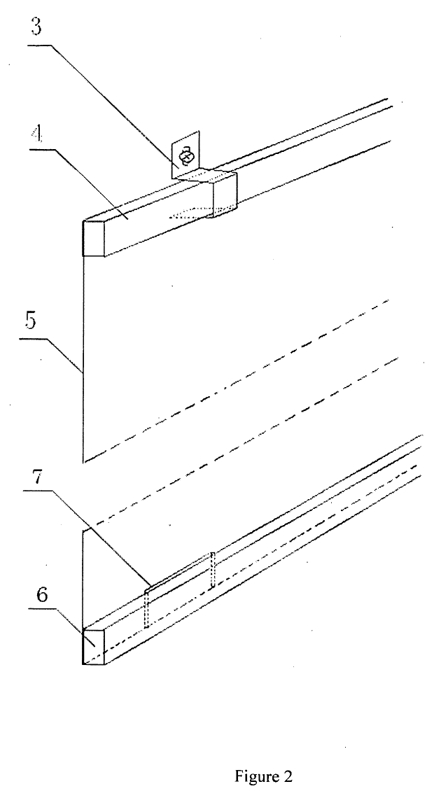

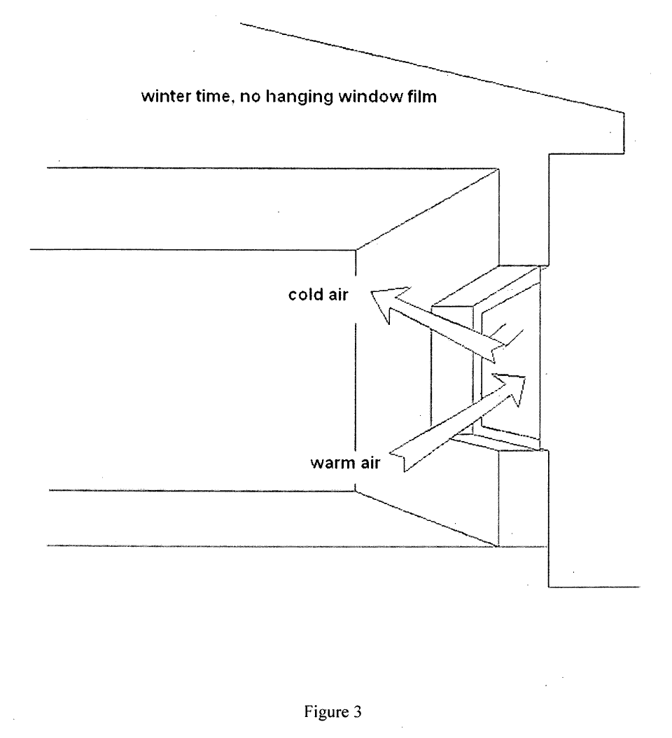

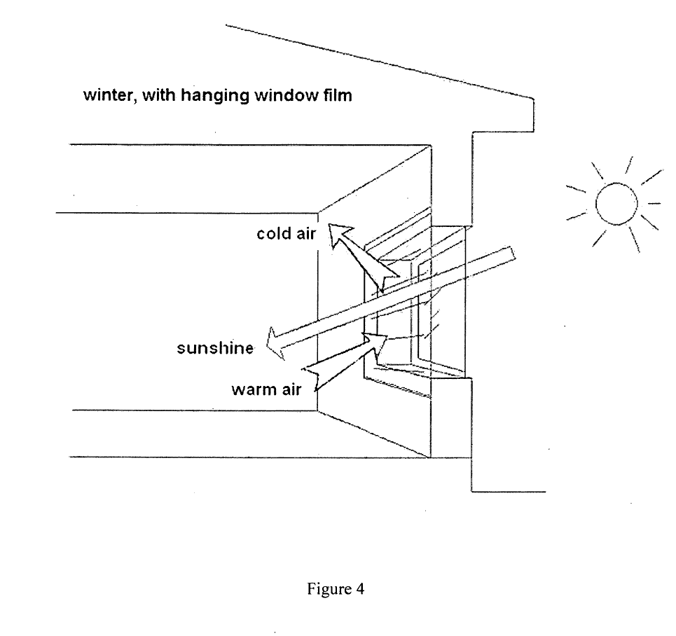

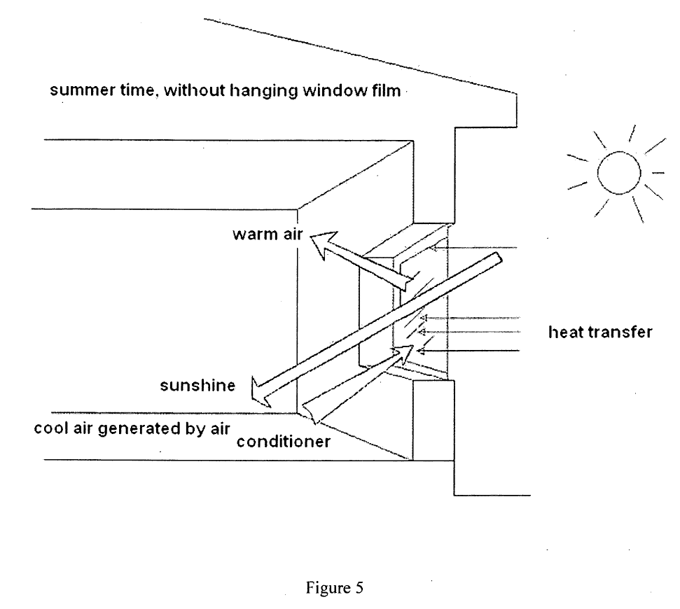

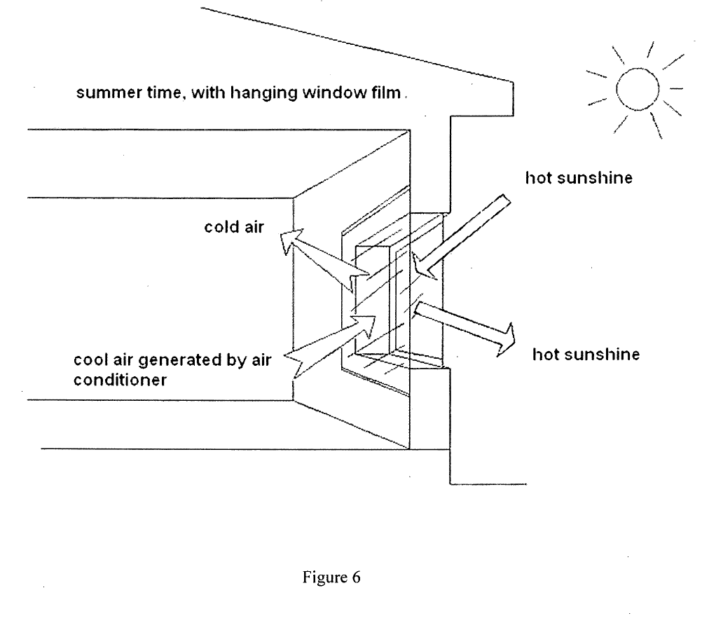

### FIELD OF INVENTION

Hanging type energy saving window film constitutes an energy saving insulation method for resident and office windows or glass doors. Window panes are very cold in winter and very hot in summer. Leakage of energy through window panes accounts for as much as 30% to 50% of heating or cooling energy. Two layers of window panes have a better insulation effect than a single window pane. Since double window panes contain a small gap of air between the two layers of window panes, the double window pane does not insulate the indoors as well as hanging type energy saving window film does. Hanging type energy saving window film serves additional insulation for single and double window pane windows and doors.

### BACKGROUND OF INVENTION

On current market, window films that insulate glass windows or glass doors are all adhesive types. Window films on the current market are directly adhered onto the entire glass window. Window films that directly adhere to the glass have a much weaker insulation effect towards heat transfer. Hanging type energy saving window film consists of a film that hangs down glass windows or glass doors to maintain a farther distance from the glass of windows or doors. This layer of air between the film and glass generate more effective insulation effect. Hanging type energy saving window film is different from conventional curtains, blinds and gutters. Conventional window curtains, blinds, shades and gutters are not transparent materials, and they are used to block the view from outside. Some curtains, blinds, shades or gutters claim to have insulation effect on windows or glass doors, but they serve to block the view of the window pane and are designed for use during the night to the block the view from outside. Hanging type energy saving window film provides window insulation and heat transfer control. Hanging type energy saving window film also allows controlled light to go through the windowpane. It is designed for an energy saving purpose and can be used during the day time with a clear view.

Hanging type energy saving window film system is also different from the curtains, blinds, shades or gutters currently on the market by the position of hanging on the window. Current curtains, blinds, gutters or shades are either hanged on top of the window frame or on the wall with a distance from wall surface. Hanging type energy saving window film system designed to hang the film on the wall and keep the film contact with the surface of the wall around the window to cover the window entirely with no air flow coming out or going in from the space between the window glass and the window film. Therefore the trapped air between the window glass and the window film serves as effective insulation cushion.

### SUMMERY OF INVENTION

Hanging type energy saving window film system includes a clear plastic film hanging on windows or glass doors as insulation or insulation and shade for energy saving purpose. Hanging type energy saving window film system also includes a method of hanging clear or semi-clear film as insulation on windows or glass doors. The hanging type energy saving window film system include any film or films have any kind of coating, thin layers of any functional effect such as effect of reflecting or absorbing UV, visible light, IR irradiation. This film could also be a plastic film coated by UV, IR absorbent or reflecting or other functional chemicals to help get better insulation or reflection or absorbing energy effect according to the needs. The functional chemicals could be a light induced color change chemical to make the film turn to dark when expose to sunshine. Hanging type energy saving window film system also includes any way of hanging the film or films on glass window or glass doors for insulation and energy saving purpose which include roller type, rigid rod type, clap type, electric motor type, adhesive type etc. The hanging type energy saving window film should keep a certain distance between film and window pane to get most effective insulation effect. There are two kinds of hanging type energy saving window films. One kind of hanging type energy saving window film is for using at summer time for clock UV, IR and Sun light and also has insulation effect from the heat outside. Another kind of hanging type energy saving window film is for using in winter time to get better insulation on window glass and also let sunshine get in to the room to keep room warm.

### DETAILED DESCRIPTION OF THE INVENTION

There are three ways of energy transfer through window pane. First way of energy transfer is irradiation, e.g. the sunshine, UV or IR irradiation. Second way is conducting, e.g. the heat transferring from the solid window frame or still air. Third way of heat transfer is convection, e.g. the flow of air caused heat transfer.

Summer time we need to reduce the heat transfer from out side to inside of the room. This could obtain by using tinted film or irradiation reflects film. We also need insulation effect to reduce the heat conduct from outside to inside the room. Keep the hanging film a distance to the window pane can make efficient insulation. The insulated air between the window pane and the film can keep minimize the convection. Therefore the summer hanging type energy saving window film should be a tinted film or irradiation reflective film to hang on the window to block the heat and light radiation.

### BRIEF DESCRIPTION OF THE DRAWINGS

1. Perspective view of hanging type energy saving window film system on window. The marked components are: (1) Window; (2) wall; (3) Hook; (4) Hanging rod; (5) Film; (6) Weight bar.

2. Enlarged partial view of the hanging type energy saving window film system. (3) Hook; (4) hanging rod; (5) film; (6) weight bar; (7) magnetic plate.

3. Schematic drawing showing that the heat energy loses during winter time, in a room without hanging type energy saving window film.

4. Schematic drawing showing that the energy saving effect during winter time, in a room with a clear hanging type energy saving window film.

5. Schematic drawing showing that energy loses during summer, in a room without tinted hanging type energy saving window film

6. Schematic drawing showing that the energy saving effect during summer time, in air conditioned room with tinted hanging type energy saving window film

We claim:

1. Hanging type energy saving window film consists of a bar or rod attached on the upper edge of the film to hold the film, a clear or tinted film, and a bar or rod attached on the bottom edge of the film to keep the film flat when hanging down the window. Hanging type energy saving window film is also comprised of two or more hooks that can be fastened to the wall above the window. The hooks serve to hold the bar or rod on top of the film. To cover a window entirely with the film, the film should be larger than the window.

2. Hanging type energy saving window film of claim 1, may include also a roller system to roll the film up and down. The roller system should be fastened to the wall above the window in order to cover the window entirely with the film.

3. Hanging type energy saving window film of claim 2, may also include a motorized rolling up system.

4. Hanging type energy saving window film of claim 1, wherein the film may be any kind of flexible material, such as plastic film etc.

5. Hanging type energy saving window film of claim 1, wherein the film may be tinted with any color.

6. Hanging type energy saving window film of claim 1, wherein the film may be reflective or semi-transparent and may contain a reflective coating or vacuum deposition coating etc.

7. Hanging type energy saving window film of claim 1, wherein, the film may contain a chemical that changes the color of the film when the film is exposed to light.

8. Hanging type energy saving window film of claim 1, wherein, the film should be larger than the window to cover the entire window or glass door.

9. Hanging type energy saving window film of claim 1, wherein the bottom of the film or the edges of the film may also contain a fastening strip to make the film adhere to the wall. The strip may have magnetic or pressure sensitive adhesive, or velcro etc.
